(19) United States
(12) Patent Application Publication
(10) Pub. No.: US 2016/0013877 A1
(43) Pub. Date: Jan. 14, 2016

(54) APPARATUS AND METHODS FOR MUD SYMBOL DETECTION AND SYMBOL-LEVEL MUD INTER-CELL PARALLEL INTERFERENCE CANCELLATION IN TD-SCDMA

(71) Applicant: QUALCOMM Incorporated, San Diego, CA (US)

(72) Inventors: Sheng-Yuan TU, San Diego, CA (US); Farrokh ABRISHAMKAR, San Diego, CA (US); Venkata Gautham CHAVALI, Hyderabad (IN); Bahadir CANPOLAT, Fleet (GB); Insung KANG, San Diego, CA (US); Ming KANG, San Diego, CA (US); Hari SANKAR, San Diego, CA (US); Aamod Dinkar KHANDEKAR, San Diego, CA (US)

(21) Appl. No.: 14/327,291

(22) Filed: Jul. 9, 2014

(51) Int. Cl. H04J 11/00

(52) U.S. Cl. CPC H04J 11/005

(57) ABSTRACT

Apparatus, methods, and computer program product for wireless communication, including receiving a plurality of chips in a time division synchronous code division multiple access (TD-SCDMA) network; performing channel matched filtering, despreading, and descrambling on the plurality of chips to determine a plurality of received symbols for each of a plurality of cells; performing symbol-level inter-cell interference cancellation on the plurality of received symbols to determine a plurality of serving cell symbol estimates; and performing multi-user detection on the plurality of serving cell symbol estimates to determine a plurality of detected serving cell symbols.

### REFERENCE TO CO-PENDING APPLICATIONS FOR PATENT

The present application for Patent is related to the following co-pending patent applications filed concurrently herewith, assigned to the assignee hereof, and expressly incorporated by reference herein:

“APPARATUS AND METHODS FOR ITERATIVE SYMBOL DETECTION AND SYMBOL-LEVEL MUD INTER-CELL PARALLEL INTERFERENCE CANCELLATION IN TD-SCDMA,” having Attorney Docket No. 141728WO, and

“APPARATUS AND METHODS FOR ITERATIVE SYMBOL DETECTION AND SYMBOL-LEVEL MUD INTER-CELL SUCCESSIVE INTERFERENCE CANCELLATION IN TD-SCDMA,” having Attorney Docket No. 141730WO.

### BACKGROUND

Aspects of the present disclosure relate generally to wireless communication systems, and more particularly, to apparatus and methods for non-linear symbol detection in Time Division-Synchronous Code Division Multiple Access (TD-SCDMA).

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, in some countries like China, TD-SCDMA is being considered as the underlying air interface in the UTRAN architecture with existing GSM infrastructure as the core network. The UMTS also supports enhanced 3G data communications protocols, such as High Speed Downlink Packet Data (HSDPA), which provides higher data transfer speeds and capacity to associated UMTS networks.

Conventionally, in TD-SCDMA, a receiver performs interference cancellation at chip-level, e.g., by processing the received chips. However, it may be computationally expensive for a receiver to operate at chip level. Therefore, there is a need for improved receivers in TD-SCDMA.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method for wireless communication is provided that includes receiving a plurality of chips in a time division synchronous code division multiple access (TD-SCDMA) network; performing channel matched filtering, despreading, and descrambling on the plurality of chips to determine a plurality of received symbols for each of a plurality of cells; performing symbol-level inter-cell interference cancellation on the plurality of received symbols to determine a plurality of serving cell symbol estimates; and performing multi-user detection on the plurality of serving cell symbol estimates to determine a plurality of detected serving cell symbols.

In another aspect, an apparatus for wireless communication is provided that includes a processing system configured to receive a plurality of chips in a TD-SCDMA network; perform channel matched filtering, despreading, and descrambling on the plurality of chips to determine a plurality of received symbols for each of a plurality of cells; perform symbol-level inter-cell interference cancellation on the plurality of received symbols to determine a plurality of serving cell symbol estimates; and perform multi-user detection on the plurality of serving cell symbol estimates to determine a plurality of detected serving cell symbols.

In a further aspect, an apparatus for wireless communication is provided that includes means for receiving a plurality of chips in a TD-SCDMA network; means for performing channel matched filtering, despreading, and descrambling on the plurality of chips to determine a plurality of received symbols for each of a plurality of cells; means for performing symbol-level inter-cell interference cancellation on the plurality of received symbols to determine a plurality of serving cell symbol estimates; and means for performing multi-user detection on the plurality of serving cell symbol estimates to determine a plurality of detected serving cell symbols.

In yet another aspect, a computer program product for wireless communication in provided that includes a non-transitory computer-readable medium including code for receiving a plurality of chips in a TD-SCDMA network; code for performing channel matched filtering, despreading, and descrambling on the plurality of chips to determine a plurality of received symbols for each of a plurality of cells; code for performing symbol-level inter-cell interference cancellation on the plurality of received symbols to determine a plurality of serving cell symbol estimates; and code for performing multi-user detection on the plurality of serving cell symbol estimates to determine a plurality of detected serving cell symbols.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system according to some present aspects;

FIG. 2 is a block diagram illustrating an example symbol-to-chip model in some present aspects;

FIG. 3 is a block diagram illustrating an example chip-to-symbol model in some present aspects;

FIG. 4 is block a diagram illustrating an example multi-cell symbol-to-symbol model in some present aspects;

FIG. 5 is a block diagram illustrating an example symbol-level inter-cell interference cancellation and symbol detection in some present aspects;

FIG. 6 is a block diagram illustrating another example symbol-level inter-cell interference cancellation and symbol detection in some present aspects;

FIG. 7 is a block diagram illustrating details of the example symbol detection in FIG. 6;

FIG. 8 is a block diagram illustrating yet another example symbol-level inter-cell interference cancellation and symbol detection in some present aspects;

FIGS. 9-13 are flow charts of example methods of wireless communication in aspects of the wireless communications system of FIG. 1;

FIG. 14 is a diagram of a hardware implementation for an apparatus employing a processing system, including aspects of the wireless communications system of FIG. 1;

FIG. 15 is a diagram illustrating an example of a telecommunications system, including aspects of the wireless communications system of FIG. 1;

FIG. 16 is a diagram illustrating an example of a frame structure in a telecommunications system, in aspects of the wireless communications system of FIG. 1; and

FIG. 17 is a diagram illustrating an example of a Node B in communication with a UE in a telecommunications system, including aspects of the wireless communications system of FIG. 1.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Some present aspects provide symbol-level interference cancellation in time division synchronous code division multiple access (TD-SCDMA). In these aspects, since a symbol rate is lower than a chip rate, interference cancellation at symbol-level may not need to be performed as quickly as at chip-level.

In some aspects, a closed form parametric model of received soft symbols as a function of transmitted symbols is provided that accounts for inter-symbol interference, inter-code interference, inter-cell interference, and thermal noise. In these aspects, a receiver may use such parametric model as a symbol-to-symbol transfer function to cancel interference at symbol level.

Some present aspects provide a two stage process where in a first stage the received chips are converted to corresponding symbols and in a second stage symbol-level interference cancellation is performed on the received symbols. In some aspects, for inter-cell interference cancellation in the second stage, successive or parallel interference cancellation is performed based on multi-user detection. In some aspects, after inter-cell interference cancellation, symbol detection is performed in the second stage for serving cell symbols based on multi-user detection. In some alternative aspects, after inter-cell interference cancellation, symbol detection is performed in the second stage by iterative hard interference cancellation without using multi-user detection and without performing covariance matrix inversion for the serving cell.

For example, in some aspects, interfering cells are cancelled with ordered successive interference cancellation using multi-user detection, and after cancellation of interfering cells, serving cell symbols are detected with iterative hard cancellation without the use of multi-user detection. These aspects may provide performance improvement of, e.g., 0.8 dB to 8 dB, over conventional chip-level interference cancellations.

In some aspects, by using a parametric symbol-to-symbol transfer function and performing interference cancellation at symbol level, a receiver is realized that provides modularity, scalability, low complexity, and ease of integration for dual subscriber identity module (SIM) dual active (DSDA) applications.

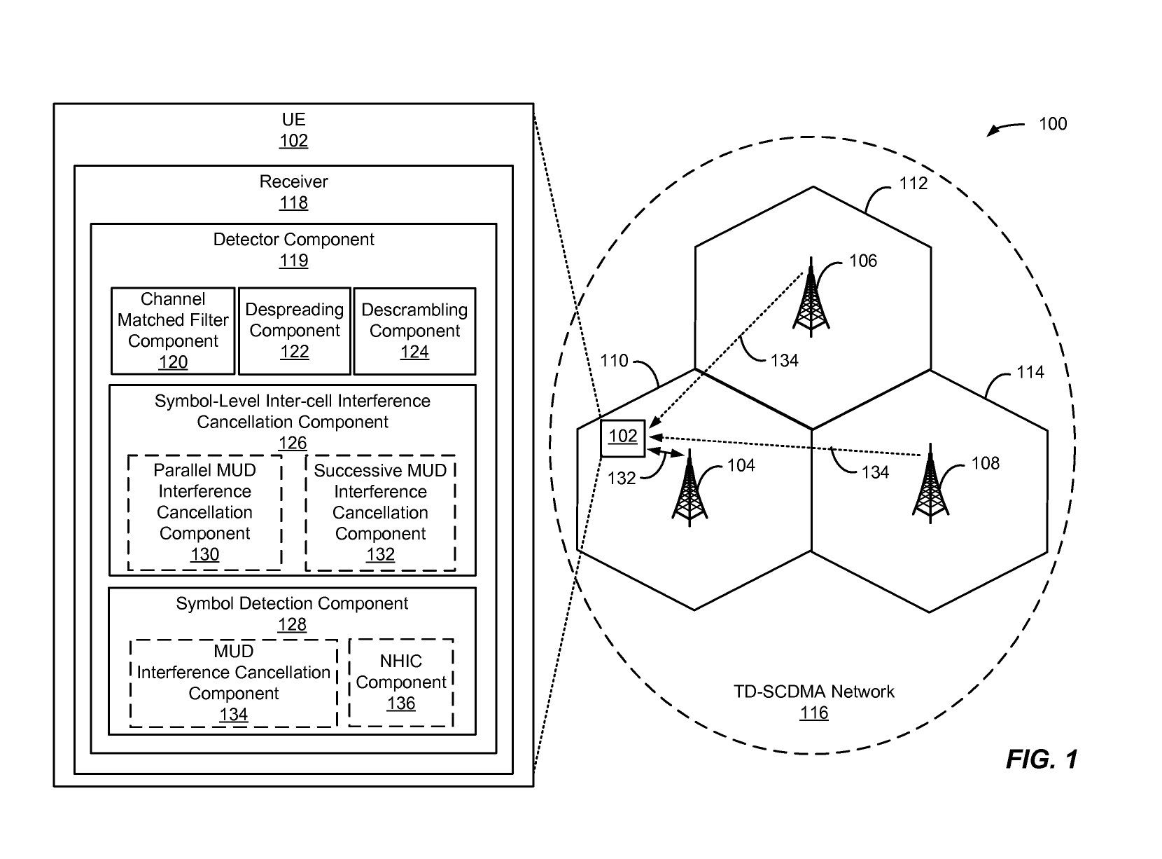

Referring to FIG. 1, a wireless communications system 100 is illustrated including detector component 119, configured to improve symbol detection in TD-SCDMA network 116. Wireless communications system 100 includes user equipment (UE) 102 that is being served by first cell 110 of TD-SCDMA network 112 and that is communicating signals 132 with first base station 104 that serves first cell 110 of TD-SCDMA network 112. UE 102 may also receive interference signals 134 from other base stations in TD-SCDMA network 116, for example, from second base station 106 and third base station 108 that, respectively, serve second cell 112 and third cell 114 of TD-SCDMA network 116.

Conventionally, in TD-SCDMA network 116, the chip rate is 1.28 megachips per second (Mcps) and the downlink time slot is 675 microseconds (μs) or 874 chips. Table 1 shows an example configuration of chips in a TD-SCDMA downlink time slot.

TABLE 1
An example configuration of chips in a TD-SCDMA downlink time slot

| | | | |
|---|---|---|---|
| Data | Midamble | Data | GP |
| (352 chips) | (144 chips) | (352 chips) | (16 chips) |

As shown in Table 1, there are 144 chips in the midamble of a TD-SCDMA downlink time slot. The midambles are training sequences for channel estimation and power measurements at UE 102. Each midamble can potentially have its own beamforming weights. Also, there is no offset between the power of the midamble and the total power of the associated channelization codes. The TD-SCDMA downlink time slot further includes 704 data chips and 16 guard period (GP) chips.

The transmitted chips, t′ (n), at the i-th antenna (i=1, . . . , Nₜ where Nₜ is the number of transmit antennas) on the downlink of TD-SCDMA network 116 in a single cell scenario may be modeled as:

$$\begin{matrix}{t}^{i} ( n ) = s ( n mod N ) {\sum }_{k = 1}^{K} {α}_{k}^{i} {g}_{k} {w}_{k} ( n mod N ) {d}_{k} ( ⌊ \frac{n}{N} ⌋ ) \\ = {\sum }_{k = 1}^{K} {α}_{k}^{i} {g}_{k} {p}_{k} ( n mod N ) {d}_{k} ( ⌊ \frac{n}{N} ⌋ )\end{matrix}$$

where dₖ is a data symbol for user k, wₖ(n) is the Walsh code for user k, s(n) is the cell scramble code (length N), pₖ(n) is the combined Walsh and scrambling code for user k, gₖ is the gain of user k, and αₖⁱ is the beamforming weight of user k at the i-th transmit antenna such that:

$$\sqrt{{\sum }_{i = 1}^{{N}_{i}} {\vert {α}_{k}^{i} \vert}^{2}} = 1$$

In some resent aspects, UE 102 includes receiver 118 and/or detector component 119 that receives downlink signals. Assuming one receive antenna at UE 102, the received chips, y(n), at receiver 118 and/or detector component 119 may be modeled as:

$$y ( n ) = {\sum }_{i}^{{N}_{t}} {\sum }_{i = 0}^{v} {h}^{i} ( l ) {t}^{i} ( n - l ) + v ( n )$$

$$where \text{:}$$

$${h}^{i} ( l ) \text{:} l = 0 , … , v$$

is the channel from the i-th transmit antenna to UE 102, and ν is additive white Gaussian noise (AWGN). The equivalent channel, \tilde{h}ₖ(l), of the k-th code may be modeled as:

$${\tilde{h}}_{k} ( l ) = {\sum }_{i = 1}^{{N}_{t}} {g}_{k} {α}_{k}^{i} {h}^{i} ( l )$$

Accordingly, the received chip, y(n), at receiver 118 and/or detector component 119 of UE 102 may be modeled as:

$$\begin{matrix}y ( n ) = {\sum }_{i = 1}^{{N}_{t}} {\sum }_{l = 0}^{v} {h}^{i} ( l ) {\sum }_{k = 1}^{K} {α}_{k}^{i} {g}_{k} {p}_{k} ( ( n - l ) mod N ) {d}_{k} ( ⌊ \frac{n - l}{N} ⌋ ) + v ( n ) \\ = {\sum }_{k = 1}^{K} {\sum }_{l = 0}^{v} {\tilde{h}}_{k} ( l ) {p}_{k} ( ( n - l ) mod N ) {d}_{k} ( ⌊ \frac{n - l}{N} ⌋ ) + v ( n )\end{matrix}$$

For N chips of user k, the combined Walsh and scrambling code is:

pₖ=[pₖ(1)pₖ(2) . . . pₖ(N)]^{T}

and the equivalent channel of user k is:

\tilde{h}ₖ=[\tilde{h}ₖ(0)hₖ(1) . . . hₖ(ν)]^{T}

Thus, the combined channel of user k may be modeled as:

cₖ=\tilde{h}ₖ\hat{×}pₖ=[cₖ(0)cₖ(1) . . . cₖ(N+ν)]^{T}

and the symbol to chip transfer function (per symbol) is:

$${C}_{( N + v ) \times K} = {[ \begin{matrix}{\underline{c}}_{1}^{T} & {\underline{c}}_{2}^{T} & … & {\underline{c}}_{k}^{T}\end{matrix} ]}^{T}$$

For channels with single symbol inter-symbol interference, the center and left equivalent channel matrices are:

$${C}_{0} = [ \begin{matrix}{c}_{1} ( 0 ) & … & {c}_{K} ( 0 ) \\ ⋮ & & ⋮ \\ {c}_{1} ( N - 1 ) & … & {c}_{K} ( N - 1 )\end{matrix} ]$$

$${C}_{- 1} = [ \begin{matrix}{c}_{1} ( N ) & … & {c}_{K} ( N ) \\ ⋮ & & ⋮ \\ {c}_{1} ( 2 N - 1 ) & … & {c}_{K} ( 2 N - 1 )\end{matrix} ]$$

Thus, for ν=N, the vector of received chips during the m-th symbol interval is:

$$\underline{y} [ m ] = [ \begin{matrix}y ( ( m - 1 ) N ) \\ ⋮ \\ y ( mN - 1 )\end{matrix} ] = {{[ \begin{matrix}{C}_{- 1} & {C}_{0}\end{matrix} ]}_{N \times 2 N} [ \begin{matrix}\underline{d} [ m - 1 ] \\ \underline{d} [ m ]\end{matrix} ]}_{ 2 N \times 1} + \underline{v} [ m ]$$

and the received chips at receiver 118 may be modeled as:

$$\underline{y} [ m ] = {C}_{- 1} \underline{d} [ m - 1 ] + {C}_{0} \underline{d} [ m ] + \underline{v} [ m ]$$

$$where$$

$${C}_{0} = {H}_{0} SWG$$

$${C}_{1 -} = {H}_{- 1} SWG$$

$${H}_{0} = {[ \begin{matrix}h ( 0 ) & 0 & … & 0 \\ h ( 1 ) & h ( 0 ) & ⋱ & ⋮ \\ ⋮ & ⋱ & ⋱ & 0 \\ h ( 15 ) & … & h ( 1 ) & h ( 0 )\end{matrix} ]}_{16 \times 16}$$

$${H}_{- 1} = {[ \begin{matrix}0 & h ( 15 ) & … & h ( 1 ) \\ ⋮ & ⋱ & ⋱ & ⋮ \\ 0 & … & 0 & h ( 15 ) \\ 0 & 0 & … & 0\end{matrix} ]}_{16 \times 16}$$

and where S is a scrambling matrix of size (16×16), W is a Walsh code matrix of size (16×16), G is a gain matrix of size (16×16), H₀ and H_{—1} are channel convolutional matrices of size (16×16), and d[m] is a vector of size (16×1) of transmitted symbols during symbol time m:

d[m]=[d₁[m]d₂[m] . . . d_{K}[m]]^{T}

Accordingly, the single-cell symbol-to-chip model may be established as:

$$[ \begin{matrix}\underline{y} [ m ] \\ \underline{y} [ m + 1 ]\end{matrix} ] = [ \begin{matrix}{C}_{- 1} & {C}_{0} & 0 \\ 0 & {C}_{- 1} & {C}_{0}\end{matrix} ] [ \begin{matrix}\underline{d} [ m - 1 ] \\ \underline{d} [ m ] \\ \underline{d} [ m + 1 ]\end{matrix} ] + [ \begin{matrix}\underline{v} [ m ] \\ \underline{v} [ m + 1 ]\end{matrix} ]$$

$$( 32 \times 1 ) ( 32 \times 48 ) ( 48 \times 1 ) ( 32 \times 1 )$$

which may be simplified as:

$$\tilde{\underline{y}} [ m ] = C \tilde{\underline{d}} [ m ] + \tilde{\underline{v}} [ m ]$$

$$C = [ \begin{matrix}{C}_{- 1} & {C}_{0} & 0 \\ 0 & {C}_{- 1} & {C}_{0}\end{matrix} ] ( 32 \times 48 )$$

Based on this single-cell symbol-to-chip model, the multi-cell symbol-to-chip model may be established as:

\tilde{y}[m]=C₁d₁[m]+C₂d₂[m]+C₃d₃[m]+\tilde{ν}[m]

where Cᵢ is a symbol-to-chip transfer function of size (32×48).

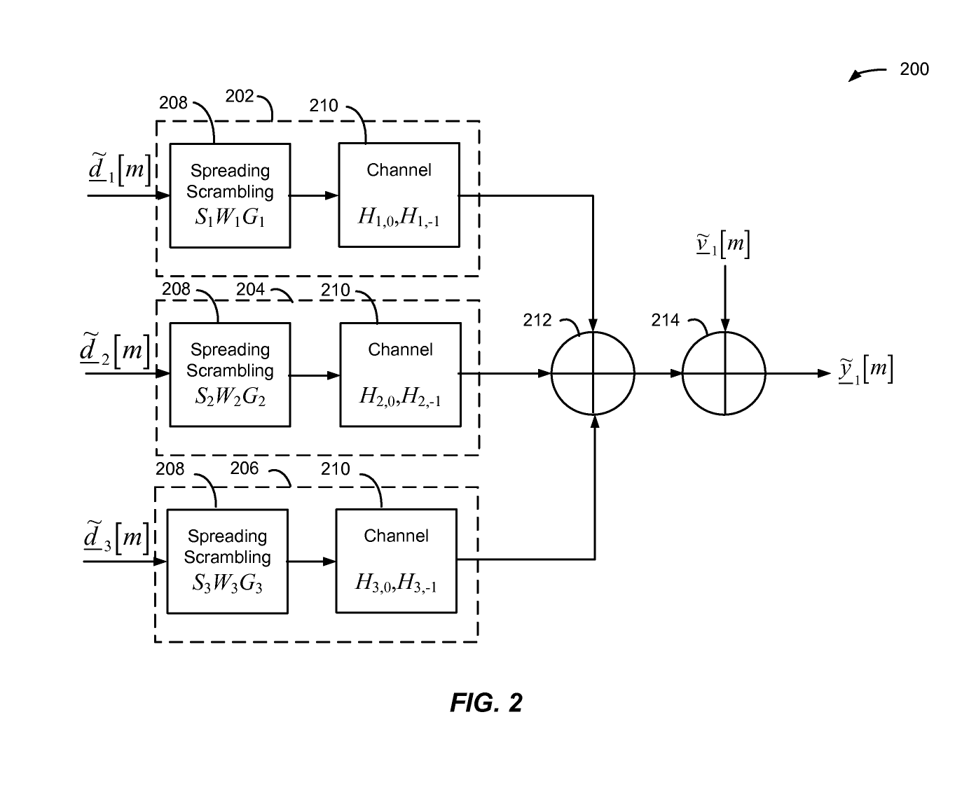

FIG. 2 is an example block diagram 200 illustrating this multi-cell joint symbol-to-chip model. In block diagram 200, blocks 202, 204, and 206, model the application of spreading, scrambling, gain, and channel transfer functions corresponding to a respective one of cells 110, 112, and 114, to a respective data vector. Each of blocks 202, 204, and 206 includes a block 208 that models the application of spreading, scrambling, and gain of a respective one of cells 110, 112, and 114, followed by a block 210 that models the application of the channel transfer function of a respective one of cells 110, 112, and 114, where Hᵢ=[H_{i,-1} H_{i,0}] is the channel convolutional matrix of size (16×32) for cell i and includes matrices and H_{i,0} of size (16×16). Block diagram 200 also includes adder 212 that models the superposition of the signals of cells 110, 112, and 114, and adder 214 that models the addition of AWGN.

Referring back to FIG. 1 and the single-cell symbol-to-chip model, in some present aspects, receiver 118 and/or detector component 119 of UE 102 include channel matched filter component 120 that applies a front end channel matched filter for post symbol-to-chip linear processing according to the equation:

$$\begin{matrix}\underline{r} [ m ] = F \underline{\tilde{y}} [ m ] \\ = FC \underline{\tilde{d}} [ m ] + F \tilde{ \underline{v}} [ m ]\end{matrix}$$

where F is a linear filter convolution matrix of size (16×32). In some aspects, for determining the received symbols, receiver 118 and/or detector component 119 of UE 102 further include despreading component 122 and descrambling component 124 that, respectively, perform descrambling and despreading according to the equation:

$$\begin{matrix}\underline{z} [ m ] = {W}^{H} {S}^{H} \underline{r} [ m ] \\ = {W}^{H} {S}^{H} FC \tilde{\underline{d}} [ m ] + {W}^{H} {S}^{H} F \tilde{\underline{v}} [ m ] \\ = A \underline{\tilde{d}} [ m ] + {W}^{H} {S}^{H} F \tilde{\underline{v}} [ m ] \\ = A \underline{\tilde{d}} [ m ] + η [ m ]\end{matrix}$$

where, for a matrix B, B^{H} denotes the Hermitian transpose of matrix B, and where the symbol-to-symbol transfer matrix A is:

A=W^{H}S^{H}FC(16×48)

and where for noise term η[m] which is defined as W^{H}S^{H}F\tilde{ν}[m], the noise covariance matrix is:

R_{η}σ²W^{H}S^{H}FF^{H}SW

Based on this single-cell symbol-to-symbol model, in some present aspects, channel matched filter component 120 applies front end channel filters for post symbol-to-chip linear processing in a three-cell system according to the equation:

$$\begin{matrix}{\underline{r}}_{i} [ m ] = {F}_{i} \underline{\tilde{y}} [ m ] \\ = {F}_{i} {\sum }_{j = 1}^{3} {C}_{j} {\underline{\tilde{d}}}_{j} [ m ] + {F}_{i} \tilde{ \underline{v}} [ m ]\end{matrix}$$

and despreading component 122 and descrambling component 124, respectively, perform descrambling and dispreading according to the equation:

$$\begin{matrix}{\underline{z}}_{i} [ m ] = {W}_{i}^{H} {S}_{i}^{H} {\underline{r}}_{i} [ m ] \\ = {W}_{i}^{H} {S}_{i}^{H} {F}_{i} {\sum }_{j = 1}^{3} {C}_{j} {\underline{\tilde{d}}}_{j} [ m ] + {W}_{i}^{H} {S}_{i}^{H} {F}_{i} \tilde{\underline{v}} [ m ] \\ = {\sum }_{j = 1}^{3} {A}_{ij} {\underline{\tilde{d}}}_{j} [ m ] + {η}_{i} [ m ]\end{matrix}$$

Accordingly, the multi-cell symbol-to-symbol model may be established as:

$${\underline{z}}_{i} [ m ] = {\sum }_{j = 1}^{{N}_{cell}} {A}_{ij} {\underline{\tilde{d}}}_{j} [ m ] + {η}_{i} [ m ]$$

$$( 16 \times 1 ) ( 16 \times 1 )$$

where index i represents the target cell (e.g., first cell 110) and index j represents the interfering cells that are different than the target cell (e.g., second cell 112 and third cell 114). In this multi-cell model, for a cell i, the front-end channel matched filter applied by channel matched filter component 120 is:

Fᵢ=[H_{i,0}^{H}H_{i,-1}^{H}](16×32)

the symbol-to-symbol transfer matrix is:

$$\begin{matrix}{A}_{ij} = {W}_{i}^{H} {S}_{i}^{H} {F}_{i} {C}_{j} \\ = {W}_{i}^{H} {S}_{i}^{H} [ \begin{matrix}{H}_{i , 0}^{H} {H}_{j , - 1} & {H}_{i , 0}^{H} {H}_{j , 0} + {H}_{i , 0}^{H} {H}_{j , - 1} & {H}_{i , - 1}^{H} {H}_{j , 0}^{H}\end{matrix} ] {S}_{j} {W}_{j} {G}_{j}\end{matrix}$$

$$( 16 \times 48 )$$

and the noise covariance matrix is:

$$\begin{matrix}{R}_{η , i} = {σ}^{2} {W}_{i}^{H} {S}_{i}^{H} {F}_{i} {F}_{i}^{H} {S}_{i} {W}_{i} \\ = {σ}^{2} {W}_{i}^{H} {S}_{i}^{H} ( {H}_{i , 0}^{H} {H}_{i , 0} + {H}_{i , - 1}^{H} {H}_{i , - 1} ) {S}_{i} {W}_{i} ( 16 \times 16 )\end{matrix}$$

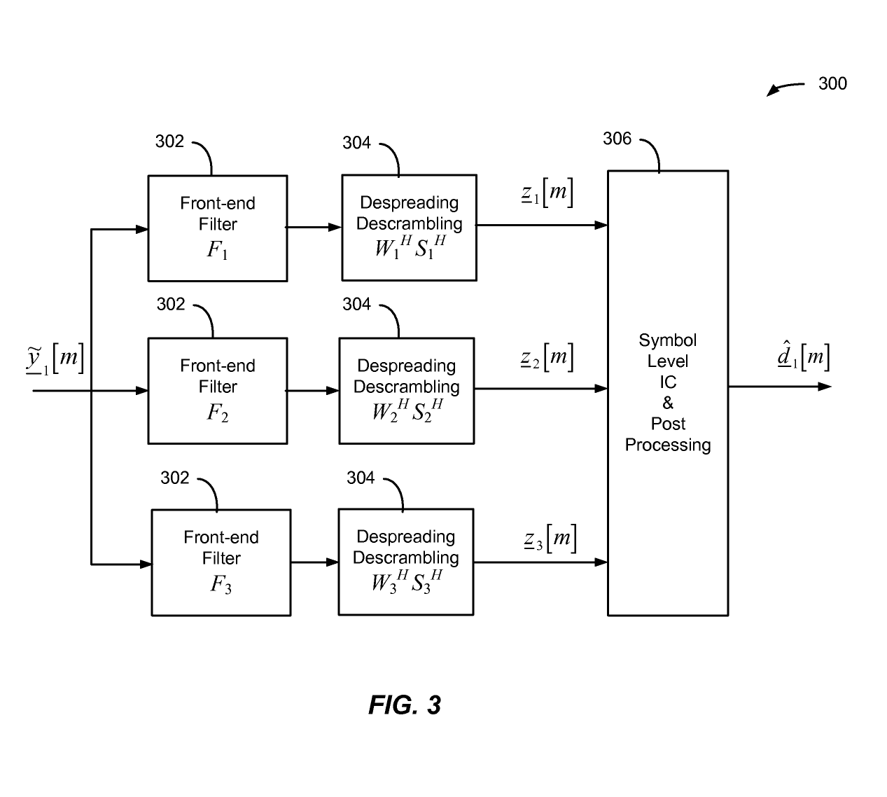

FIG. 3 is an example block diagram 300 illustrating an example chip-to-symbol model for symbol-level processing of received chips at receiver 118 and/or detector component 119 of UE 102. In block diagram 300 of FIG. 3, for each of first cell 110, second cell 112, and third cell 114, at a respective block 302, a respective front end channel filter is applied to the received chips. For example, in some aspects, for each of first cell 110, second cell 112, and third cell 114, channel matched filter component 120 may apply a respective front end channel filter to the received chips.

Then, for each of first cell 110, second cell 112, and third cell 114, at a respective block 304, respective descrambling and dispreading are performed to determine a respective received symbol. For example, in some aspects, for each of first cell 110, second cell 112, and third cell 114, despreading component 122 and descrambling component 124 respectively perform descrambling and dispreading to determine a respective received symbol.

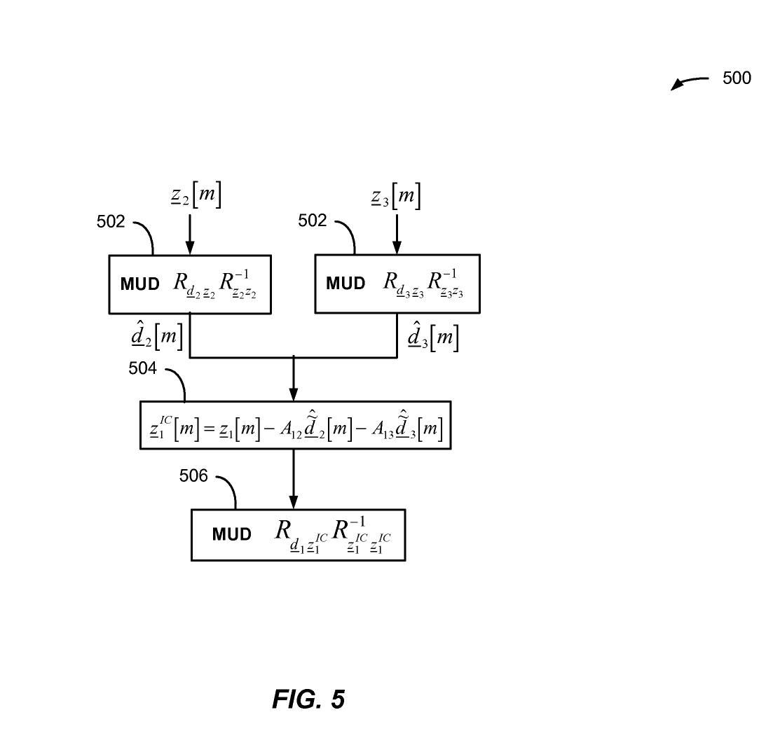

Block diagram 300 also includes a block 306 at which symbol-level interference cancellation and post processing is performed on the received symbols to detect the symbols of the serving cell 110. For example, in some present aspects, receiver 118 and/or detector component 119 further include symbol-level interference cancellation component 126 and symbol detection component 128 that, respectively, perform symbol-level interference cancellation and symbol detection. Further details of example aspects for symbol-level interference cancellation and symbol detection are provided herein with reference to FIGS. 5-8.

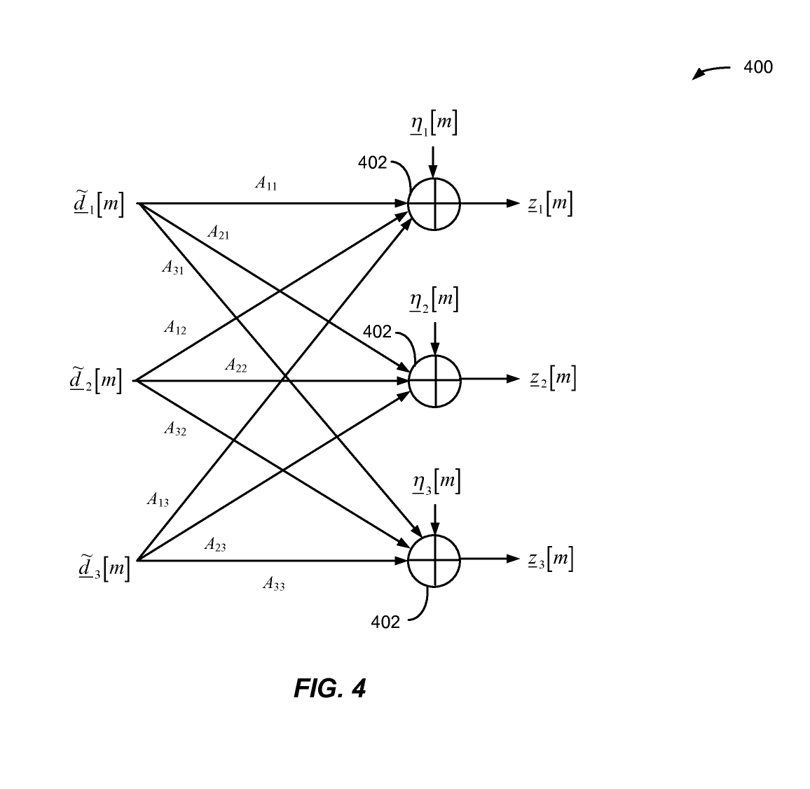

FIG. 4 is a block diagram 400 illustrating a multi-cell symbol-to-symbol model corresponding to the symbol-to-symbol transfer functions described herein with reference to blocks 302 and 304 of FIG. 3. In block diagram 400 of FIG. 4, each received symbol at receiver 118 and/or detector component 119 is modeled as a superposition 402 of AWGN and matrix products of the transmitted symbols of first cell 110, second cell 112, and third cell 114, using respective symbol-to-symbol transfer matrices Aᵢⱼ and AWGN noise covariance matrices ηᵢ as described herein. Accordingly, since the symbol-to-symbol transfer matrices Aᵢⱼ and the AWGN noise covariance matrices ηᵢ are functions of cell parameters of first cell 110, second cell 112, and third cell 114, block diagram 400 provides a parametric multi-cell symbol-to-symbol model.

FIG. 5 is a block diagram 500 illustrating one example aspect of symbol-level inter-cell interference cancellation and symbol detection performed, respectively, by symbol-level inter-cell interference cancellation component 126 and symbol detection component 128 of receiver 118 and/or detector component 119 of UE 102. As used in block diagram 500 of FIG. 5, indices 2 and 3 refer to interfering cells which may correspond to second cell 112 and third cell 114 in FIG. 1, and index 1 refers to a serving cell which may correspond to first cell 110 in FIG. 1.

At blocks 502, symbol-level inter-cell interference cancellation component 126 (FIG. 1) performs symbol-level parallel interference cancellation based on multi-user detection (MUD) to remove the contribution of the symbols of the interfering cells from the symbols of the serving cell. For example, in some aspects, symbol-level inter-cell interference cancellation component 126 includes parallel MUD interference cancellation component 130 that, for a respective interfering cell i, performs multi-user detection based on the covariance matrix of the interfering cell i:

$${R}_{{\underline{z}}_{i} {\underline{z}}_{i}} = {\sum }_{j = 1}^{{N}_{cell}} {A}_{ij} {A}_{ij}^{H} + {R}_{η , i} ( 16 \times 16 )$$

and the cross-correlation matrix:

$${R}_{{\underline{d}}_{i} {\underline{z}}_{i}} = {G}_{i}^{H} {W}_{i}^{H} {S}_{i}^{H} ( {H}_{i , 0}^{H} {H}_{i , 0} + {H}_{i , - 1}^{H} {H}_{i , - 1} ) {S}_{i} {W}_{i} ( 16 \times 16 )$$

Then, at block 504, based on the detected symbols of the interfering cells, parallel MUD interference cancellation component 130 performs inter-cell interference cancellation on the serving cell symbols according to:

z₁^{IC}[m]=z₁[m]−A₁₂{circumflex over (\tilde{d}₂[m]−A₁₃{circumflex over (\tilde{d}₃[m]

Block diagram 500 also includes block 506 at which symbol detection of serving cell i is performed by symbol detection component 128 based on MUD. For example, symbol detection component 128 may include MUD interference cancellation component 134 that performs multi-user detection on the serving cell symbols based on the covariance matrix of the serving cell:

$${R}_{{{\underline{z}}_{1}}^{IC} {{\underline{z}}_{1}}^{IC}} = {A}_{11} {A}_{11}^{H} + {R}_{η , 1} ( 16 \times 16 )$$

and the cross-correlation matrix:

$${R}_{{\underline{d}}_{1} {{\underline{z}}_{1}}^{IC}} = {G}_{1}^{H} {W}_{1}^{H} {S}_{1}^{H} ( {H}_{1 , 0}^{H} {H}_{1 , 0} + {H}_{1 , - 1}^{H} {H}_{1 , - 1} ) {S}_{1} {W}_{1} ( 16 \times 16 )$$

Accordingly, by performing both of inter-cell interference cancellation and symbol detection based on multi-user detection, a receiver with low complexity hardware may be realized.

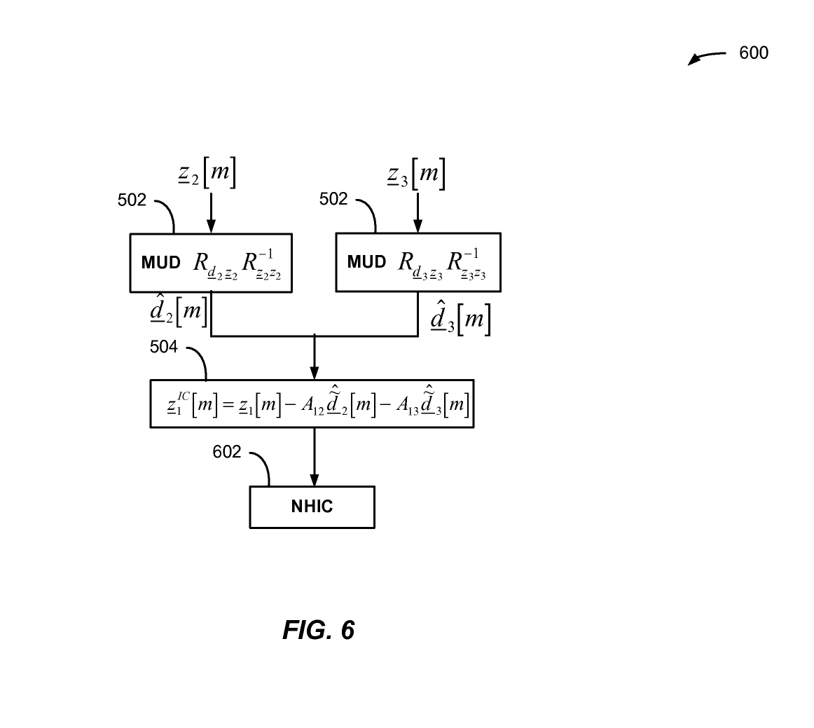

FIG. 6 is a block diagram 600 illustrating another example aspect of symbol-level interference cancellation and symbol detection performed, respectively, by symbol-level inter-cell interference cancellation component 126 and symbol detection component 128 of receiver 118 and/or detector component 119 of UE 102. As used in block diagram 600 of FIG. 6, indices 2 and 3 refer to interfering cells which may correspond to second cell 112 and third cell 114 in FIG. 1, and index 1 refers to a serving cell which may correspond to first cell 110 in FIG. 1

Block diagram 600 includes blocks 502 and 504 that perform symbol-level inter-cell parallel interference cancellation based on multi-user detection as described herein with reference to same blocks in block diagram 500.

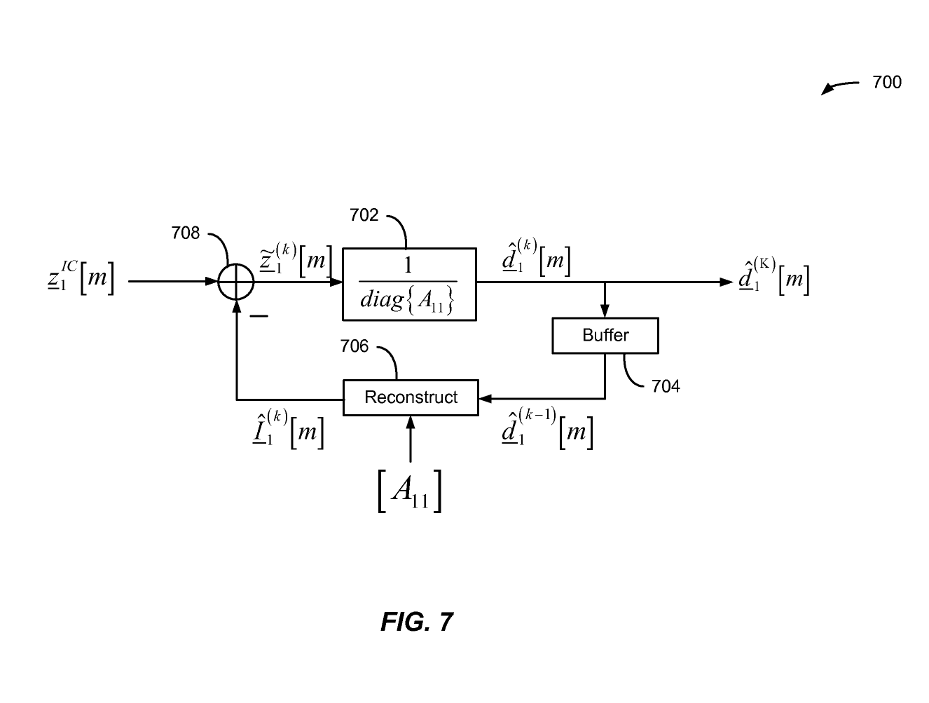

However, in block diagram 600, after inter-cell interference cancellation, symbol detection component 128 of receiver 118 and/or detector component 119 (FIG. 1) performs symbol detection at block 602 based on non-linear hard iterative interference cancellation (NHIC) which is an iterative process that does not require the calculation of the covariance matrix of the serving cell and does not require multi-user detection at the serving cell. For example, in some aspects, symbol detection component 128 may include NHIC component 136 that performs symbol detection based on non-linear hard iterative interference cancellation as described herein with reference to FIG. 7.

FIG. 7 is a block diagram 700 illustrating one example aspect of NHIC symbol detection performed by NHIC component 136 (FIG. 1). At each iteration k, at block 706, NHIC component 136 multiplies the current estimate of the detected symbol by matrix A₁₁ and removes its diagonal elements according to:

\hat{I}₁^{(k)}[m]=A₁₁\hat{d}₁^{(k-1)}[m]−diag{A₁₁}\hat{d}₁^{(k-1)}[m]

Then, at block 708, NHIC component 136 subtracts the result of block 706 from the received symbol according to:

\tilde{z}₁^{(k)}[m]=z₁^{IC}[m]−\hat{I}₁^{(k)}[m]

Subsequently, at block 702, NHIC component 136 scales down each diagonal element of the result of block 708 by a respective diagonal element of matrix A₁₁, resulting in a new estimate of the detected symbol which is buffered at block 704 to be used in a next iteration.

Accordingly, by performing iterative interference cancellation at the serving cell without using multi-user detection or matrix inversion, a receiver with low complexity software may be achieved.

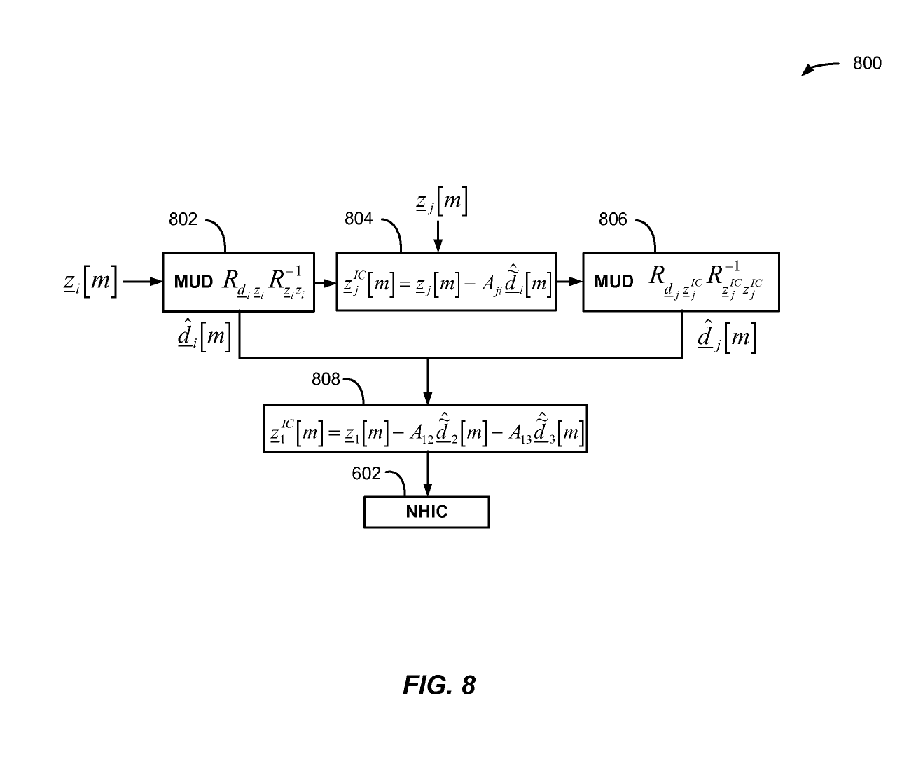

FIG. 8 is a block diagram 800 illustrating yet another example aspect of symbol-level interference cancellation and symbol detection performed, respectively, by symbol-level inter-cell interference cancellation component 126 and symbol detection component 128 of receiver 118 and/or detector component 119 of UE 102 (FIG. 1). As used in block diagram 800 of FIG. 8, index i refers to a strongest interfering cell which may correspond to second cell 112 in FIG. 1, index j refers to a second strongest interfering cell which may correspond to third cell 114 in FIG. 1, and index 1 refers to a serving cell which may correspond to first cell 110 in FIG. 1.

At blocks 802, 804, and 806, symbol-level inter-cell interference cancellation component 126 performs symbol-level ordered successive interference cancellation based on MUD to remove the contribution of the symbols of the interfering cells from the symbols of the serving cell. For example, in some aspects, symbol-level inter-cell interference cancellation component 126 of receiver 118 and/or detector component 119 of UE 102 includes successive MUD interference cancellation component 132 that performs symbol-level ordered successive interference cancellation based on MUD. More specifically, at block 802, for the strongest interfering cell i, successive MUD interference cancellation component 132 performs multi-user detection based on the covariance matrix of the strongest interfering cell i:

$${R}_{{\underline{z}}_{i} {\underline{z}}_{i}} = {\sum }_{j = 1}^{{N}_{cell}} {A}_{ij} {A}_{ij}^{H} + {R}_{η , i} ( 16 \times 16 )$$

and the cross-correlation matrix:

$${R}_{{\underline{d}}_{i} {\underline{z}}_{i}} = {G}_{i}^{H} {W}_{i}^{H} {S}_{i}^{H} ( {H}_{i , 0}^{H} {H}_{i , 0} + {H}_{i , - 1}^{H} {H}_{i , - 1} ) {S}_{i} {W}_{i} ( 16 \times 16 )$$

Then, at block 804, successive MUD interference cancellation component 132 uses the detected symbol of the strongest interfering cell i to update the received symbol of the second strongest interfering cell j, and subsequently, at block 806, successive MUD interference cancellation component 132 performs multi-user detection on the updated received symbols of the second strongest interfering cell j based on the covariance matrix of the second strongest interfering cell j:

$${R}_{{{\underline{z}}_{j}}^{IC} {{\underline{z}}_{j}}^{IC}} = {\sum }_{{l = 1}_{l \neq i}}^{{N}_{cell}} {A}_{jl} {A}_{jl}^{H} + {R}_{η , j} ( 16 \times 16 )$$

and the cross-correlation matrix:

$${R}_{{\underline{d}}_{j} {{\underline{z}}_{j}}^{IC}} = {G}_{j}^{H} {W}_{j}^{H} {S}_{j}^{H} ( {H}_{j , 0}^{H} {H}_{j , 0} + {H}_{j , - 1}^{H} {H}_{j , - 1} ) {S}_{j} {W}_{j} ( 16 \times 16 )$$

Block diagram 800 also includes block 808 at which, based on the detected symbols of the interfering cells, successive MUD interference cancellation component 132 performs inter-cell interference cancellation on the serving cell symbols according to:

z₁^{IC}[m]=z₁[m]−A₁ᵢdᵢ[m]−A₁ⱼdⱼ[m]

Following ordered successive inter-cell interference cancellation, block diagram 800 includes 602 at which NHIC component 136 performs symbol detection on the estimated serving cell symbols based on NHIC as described herein with reference to the same block in FIG. 6 and in more detail with reference to FIG. 7.

Accordingly, by performing ordered successive inter-cell interference cancellation, a receiver with better performance may be achieved compared to a receiver that uses parallel inter-cell interference cancellation.

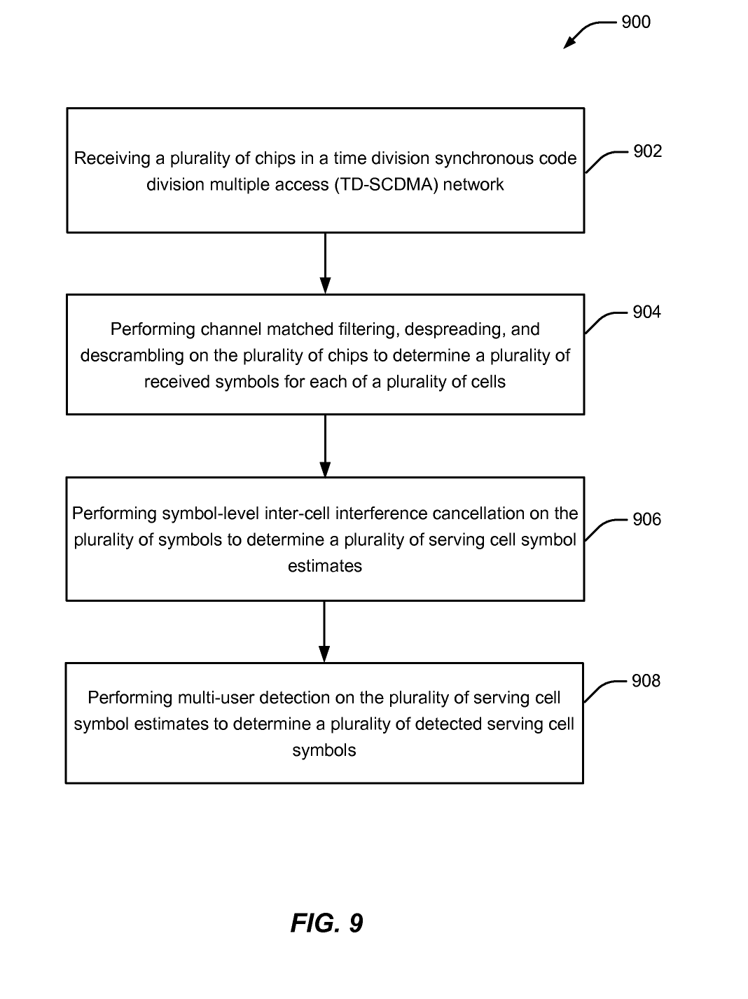

FIGS. 9-13 describe methods 900, 1000, 1100, 1200, and 1300, respectively, in aspects of the wireless communications system of FIG. 1. For example, methods 900, 1000, 1100, 1200, and 1300 may be performed by UE 102 executing receiver 118 and/or detector component 119 (FIG. 1) or respective components thereof as described herein, where method 900 relates to an aspect of performing symbol detection in TD-SCDMA, method 1000 relates to an aspect of performing channel matched filtering, despreading, and descrambling, method 1100 relates to an aspect of performing symbol-level inter-cell interference cancellation, method 1200 relates to an aspect of symbol-level parallel inter-cell interference cancellation, and method 1300 relates to an aspect of performing multi-user detection on a plurality of serving cell symbol estimates.

Referring now to FIG. 900, in an aspect of a method of wireless communication in which receiver 118, detector component 119, and/or UE 102 perform interference cancellation at symbol level in TD-SCDMA, at block 902, method 900 includes receiving a plurality of chips in a TD-SCDMA network. For example, in some aspects, receiver 118 and/or detector component 119 of UE 102 may receive a plurality of chips in TD-SCDMA network 116, where the plurality of chips may correspond to the multi-cell symbol-to-chip model described herein with reference to FIG. 2.

At block 904, method 900 includes performing channel matched filtering, despreading, and descrambling on the plurality of chips to determine a plurality of received symbols for each of a plurality of cells. For example, in some aspects, receiver 118 and/or detector component 119 and/or a respective one of channel matched filter component 120, despreading component 122, and descrambling component 124 perform channel matched filtering, despreading, and descrambling on the plurality of chips, as described herein with reference to a respective one of blocks 302 and blocks 304 of FIG. 3, to determine a plurality of received symbols for each one of first cell 110, second cell 112, and third cell 114.

In some aspects, the plurality of received symbols include a plurality of serving cell symbols corresponding to a serving cell which may be first cell 110, a first plurality of symbols corresponding to a first interfering cell which may be second cell 112, and a second plurality of symbols corresponding to a second interfering cell which may be third cell 114.

At block 906, method 900 includes performing symbol-level inter-cell interference cancellation on the plurality of received symbols to determine a plurality of serving cell symbol estimates. For example, in some aspects, receiver 118 and/or detector component 119 and/or symbol-level inter-cell interference cancellation component 126 perform symbol-level inter-cell interference cancellation on the plurality of received symbols to determine a plurality of serving cell symbol estimates for first cell 110, as described herein with reference to block 306 of FIG. 3.

At block 908, method 900 includes performing multi-user detection on the plurality of serving cell symbol estimates to determine a plurality of detected serving cell symbols. For example, in some aspects, receiver 118 and/or detector component 119 and/or symbol detection component 128 and/or MUD interference cancellation component 134 perform multi-user detection on the plurality of serving cell symbol estimates to determine a plurality of detected serving cell symbols, as described herein with reference to block 506 of FIG. 5.

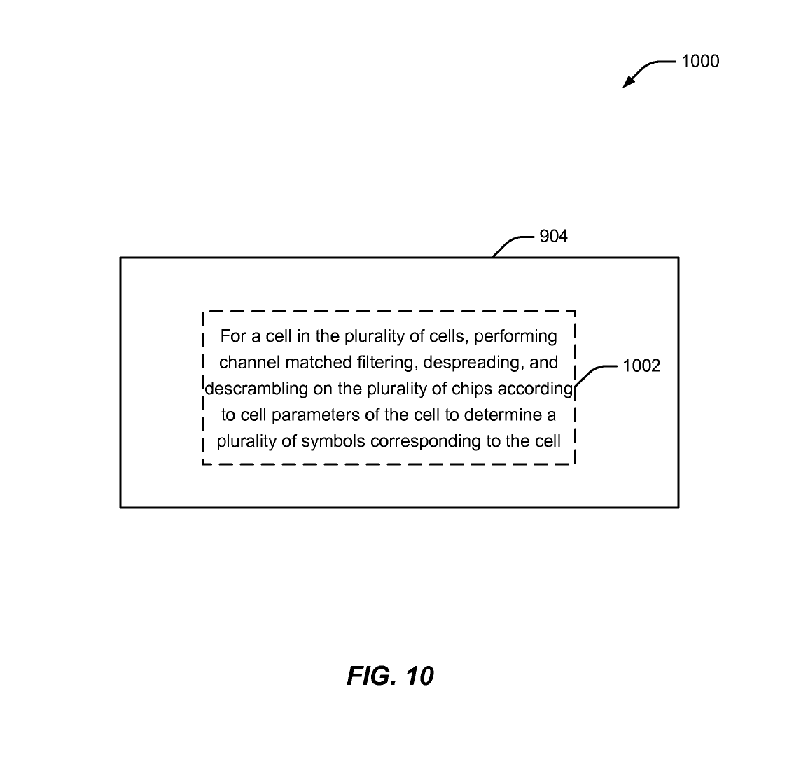

Referring to FIG. 10, method 1000 includes further, and optional, aspects related to block 904 of method 900 of FIG. 9 for performing channel matched filtering, despreading, and descrambling on the plurality of chips.

At optional block 1002, method 1000 includes, for a cell in the plurality of cells, performing channel matched filtering, despreading, and descrambling on the plurality of chips according to cell parameters of the cell to determine a plurality of symbols corresponding to the cell. For example, in some aspects, for each of first cell 110, second cell 112, and third cell 114, receiver 118 and/or detector component 119 and/or a respective one of channel matched filter component 120, despreading component 122, and descrambling component 124 respectively perform channel matched filtering, despreading, and descrambling on the plurality of chips according to cell parameters of that cell to determine a plurality of symbols corresponding to that cell, as described herein with reference to a respective one of blocks 302 and blocks 304 of FIG. 3.

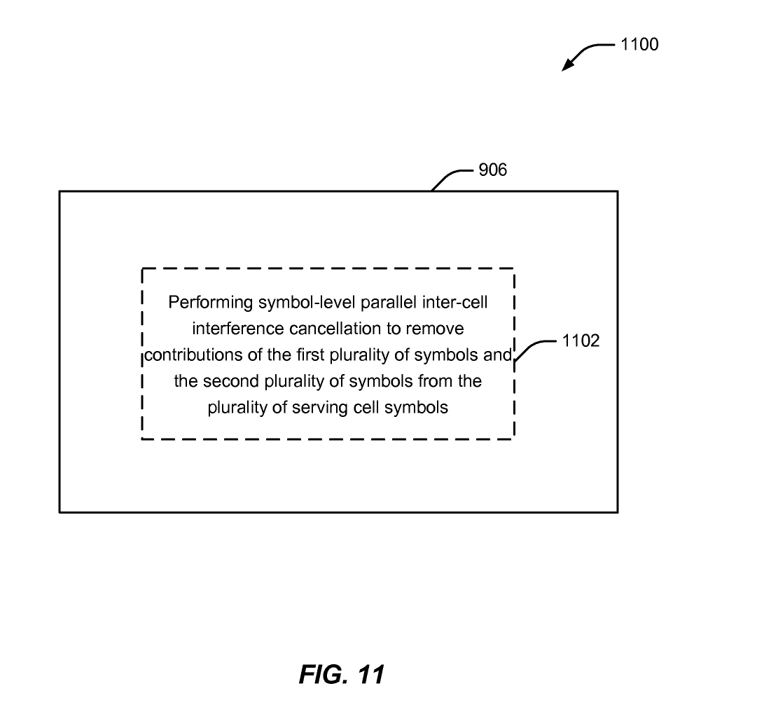

Referring to FIG. 11, method 1100 includes further, and optional, aspects related to block 906 of method 900 of FIG. 9 for performing symbol-level inter-cell interference cancellation.

At optional block 1102, method 1100 includes performing symbol-level parallel inter-cell interference cancellation to remove contributions of the first plurality of symbols and the second plurality of symbols from the plurality of serving cell symbols. For example, in some aspects, parallel MUD interference cancellation component 130 may perform symbol-level parallel inter-cell interference cancellation to remove contributions of the first plurality of symbols (corresponding to second cell 112) and the second plurality of symbols (corresponding to third cell 114) from the plurality of serving cell symbols (corresponding to first cell 110), as described herein with reference to a respective one of blocks 502 and block 504 of FIG. 5.

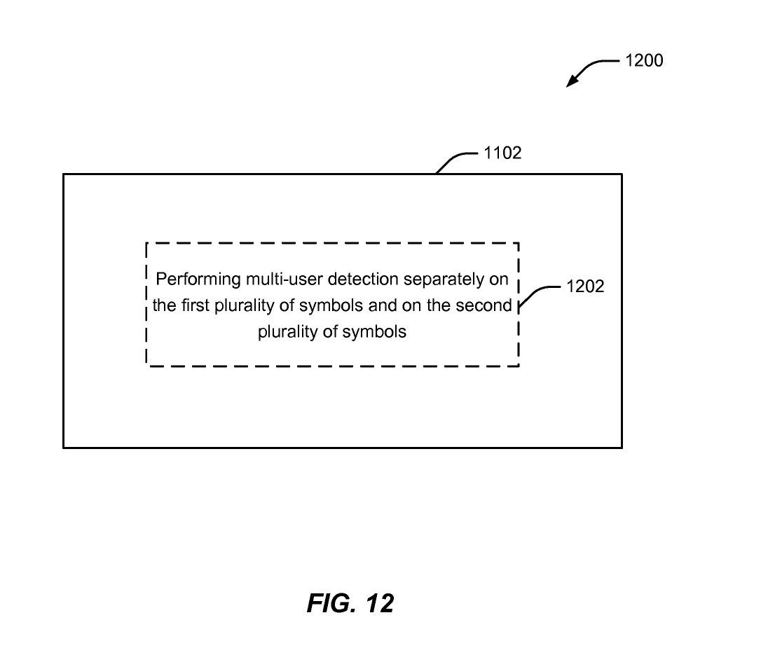

Referring to FIG. 12, method 1200 includes further, and optional, aspects related to block 1102 of method 1100 of FIG. 11 for symbol-level parallel inter-cell interference cancellation.

At optional block 1202, method 1200 includes performing multi-user detection separately on the first plurality of symbols and on the second plurality of symbols. For example, in some aspects, parallel MUD interference cancellation component 130 may perform multi-user detection separately on the first plurality of symbols (corresponding to second cell 112) and on the second plurality of symbols (corresponding to third cell 114), as described herein with reference to a respective one of blocks 502 of FIG. 5.

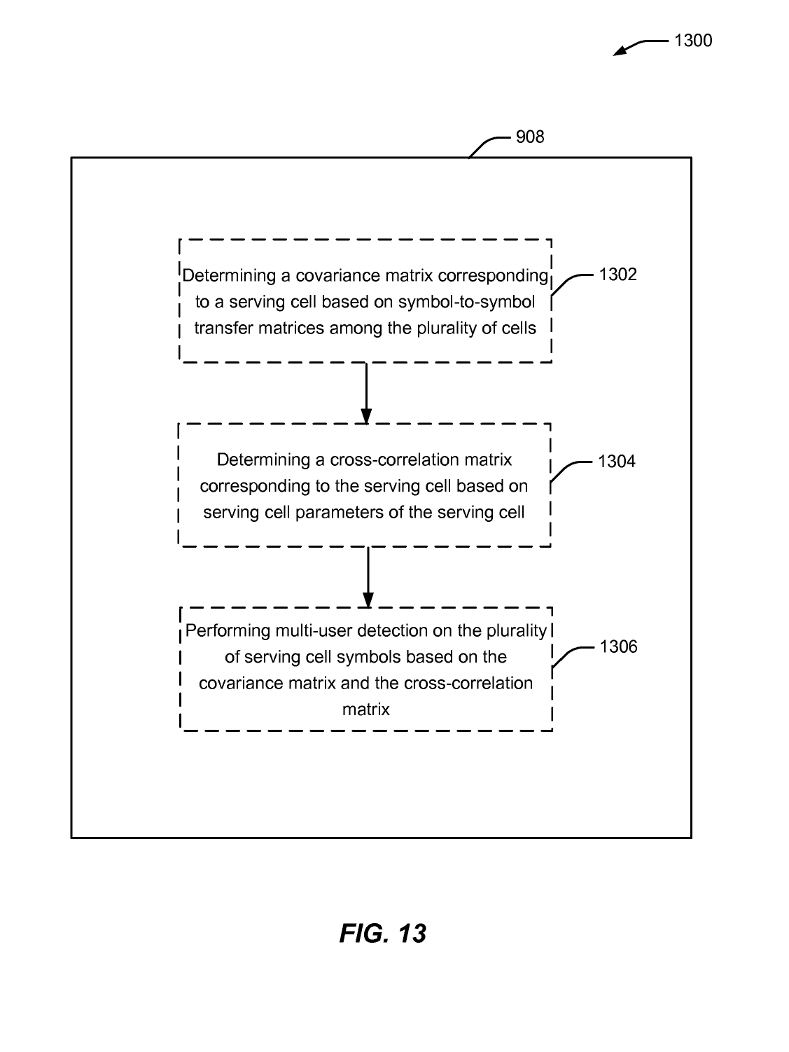

Referring to FIG. 13, method 1300 includes further, and optional, aspects related to block 908 of method 900 of FIG. 9 for performing multi-user detection on the plurality of serving cell symbol estimates to determine a plurality of detected serving cell symbols.

At optional block 1302, method 1300 includes determining a covariance matrix corresponding to a serving cell based on symbol-to-symbol transfer matrices among the plurality of cells. For example, in some aspects, MUD interference cancellation component 134 may determine a covariance matrix corresponding to a serving cell (corresponding to first cell 110), based on symbol-to-symbol transfer matrices among the plurality of cells (e.g., among first cell 110, second cell 112, and third cell 114), as described herein with reference to block 506 of FIG. 5.

At optional block 1304, method 1300 includes determining a cross-correlation matrix corresponding to the serving cell based on serving cell parameters of the serving cell. For example, in some aspects, MUD interference cancellation component 134 may determine a cross-correlation matrix corresponding to the serving cell (corresponding to first cell 110) based on serving cell parameters of the serving cell, as described herein with reference to block 506 of FIG. 5.

At optional block 1306, method 1300 includes performing multi-user detection on the plurality of serving cell symbols based on the covariance matrix and the cross-correlation matrix. For example, in some aspects, MUD interference cancellation component 134 may perform multi-user detection on the plurality of serving cell symbols based on the covariance matrix and the cross-correlation matrix, as described herein with reference to block 506 of FIG. 5.

In some aspects, the symbol-to-symbol transfer matrices are based on cell parameters of the plurality of cells, as described herein with reference to the example multi-cell symbol-to-symbol model in FIG. 4. In some further aspects, the cell parameters and the serving cell parameters comprise one or more of a scrambling matrix, a Walsh code, a gain matrix, and a channel convolutional matrix, as described herein with reference to the example multi-cell symbol-to-symbol model in FIG. 4.

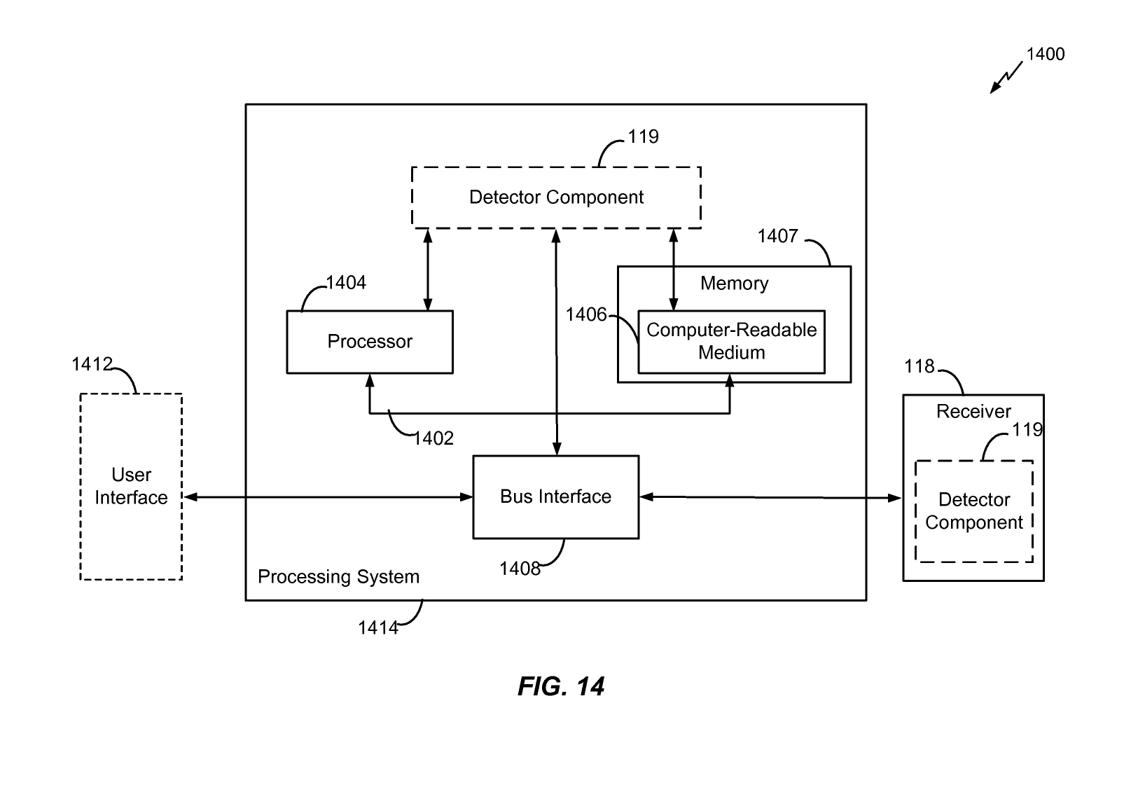

Referring to FIG. 14, an example of a hardware implementation for an apparatus 1400 including detector component 119 and employing a processing system 1414 is shown. In an aspect, apparatus 1400 may be UE 102 of FIG. 1, including receiver 118, and may be configured to perform any functions described herein with reference to UE 102 and/or receiver 118 and/or detector component 119. In this aspect, detector component 119 is illustrated as being optionally implemented separate from, but in communication with, receiver 118. Further, in this aspect, detector component 119 may be implemented as one or more processor modules in a processor 1404 of UE 102, as computer-readable instructions stored in a computer-readable medium 1406 in a memory 1407 of UE 102 and executed by processor 1404 of UE 102, or some combination of both.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 links together various circuits including one or more processors, represented generally by the processor 1404, one or more communications components, such as, for example, detector component 119 of FIG. 1, and computer-readable media, represented generally by the computer-readable medium 1406. The bus 1402 may also link various other circuits such as timing sources, peripherals, voltage regulators, and power management circuits, which are well known in the art, and therefore, will not be described any further. A bus interface 1408 provides an interface between the bus 1402 and a receiver 118, which may be part of a transceiver (not shown). The receiver 118 and/or transceiver (not shown) provide a means for communicating with various other apparatus over a transmission medium. Depending upon the nature of the apparatus, a user interface 1412 (e.g., keypad, display, speaker, microphone, joystick) may also be provided.

The processor 1404 is responsible for managing the bus 1402 and general processing, including the execution of software stored on the computer-readable medium 1406. The software, when executed by the processor 1404, causes the processing system 1414 to perform the various functions described herein for any particular apparatus.

The computer-readable medium 1406 may also be used for storing data that is manipulated by the processor 1404 when executing software, such as, for example, software modules represented by receiver 118. In one example, the software modules (e.g., any algorithms or functions that may be executed by processor 1404 to perform the described functionality) and/or data used therewith (e.g., inputs, parameters, variables, and/or the like) may be retrieved from computer-readable medium 1406. The modules may be software modules running in the processor 1404, resident and/or stored in the computer-readable medium 1406, one or more hardware modules coupled to the processor 1404, or some combination thereof.

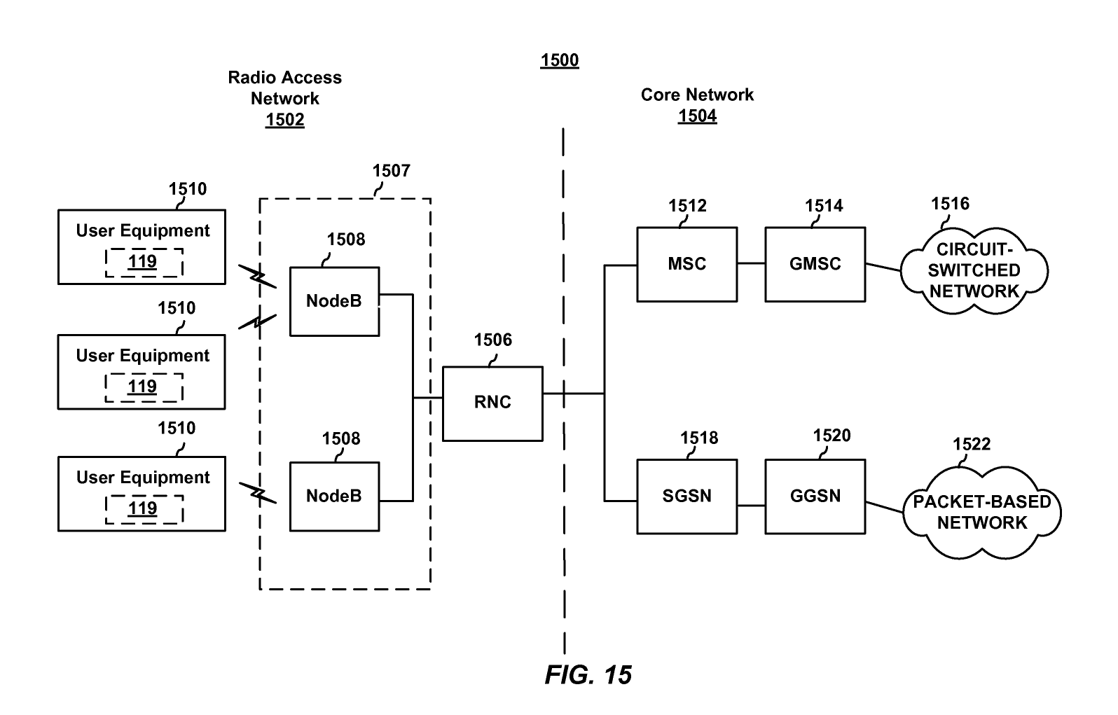

Turning now to FIG. 15, a block diagram is shown illustrating an example of a telecommunications system 1500. Telecommunications system 1500 includes UEs 1510 which may be examples of UE 102 of FIG. 1 and which may include and execute detector component 119 to perform any functions described herein. The various concepts presented throughout this disclosure may be implemented across a broad variety of telecommunication systems, network architectures, and communication standards. By way of example and without limitation, the aspects of the present disclosure illustrated in FIG. 15 are presented with reference to a UMTS system employing a TD-SCDMA standard. In this example, the UMTS system includes a (radio access network) RAN 1502 (e.g., UTRAN) that provides various wireless services including telephony, video, data, messaging, broadcasts, and/or other services. The RAN 1502 may be divided into a number of Radio Network Subsystems (RNSs) such as an RNS 1507, each controlled by a Radio Network Controller (RNC) such as an RNC 1506. For clarity, only the RNC 1506 and the RNS 1507 are shown; however, the RAN 1502 may include any number of RNCs and RNSs in addition to the RNC 1506 and RNS 1507. The RNC 1506 is an apparatus responsible for, among other things, assigning, reconfiguring and releasing radio resources within the RNS 1507. The RNC 1506 may be interconnected to other RNCs (not shown) in the RAN 1502 through various types of interfaces such as a direct physical connection, a virtual network, or the like, using any suitable transport network.

The geographic region covered by the RNS 1507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 1508 are shown; however, the RNS 1507 may include any number of wireless Node Bs. The Node Bs 1508 provide wireless access points to a core network 1504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 1510, which may be the same as or similar to UE 102 of FIG. 1, are shown in communication with the Node Bs 1508, which may be the same as or similar to first base station 104, second base station 106, or third base station 108 of FIG. 1. The downlink (DL), also called the forward link, refers to the communication link from a Node B to a UE, and the uplink (UL), also called the reverse link, refers to the communication link from a UE to a Node B.

The core network 1504, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 1504 supports circuit-switched services with a mobile switching center (MSC) 1512 and a gateway MSC (GMSC) 1514. One or more RNCs, such as the RNC 1506, may be connected to the MSC 1512. The MSC 1512 is an apparatus that controls call setup, call routing, and UE mobility functions. The MSC 1512 also includes a visitor location register (VLR) (not shown) that contains subscriber-related information for the duration that a UE is in the coverage area of the MSC 1512. The GMSC 1514 provides a gateway through the MSC 1512 for the UE to access a circuit-switched network 1516. The GMSC 1514 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 1514 queries the HLR to determine the UE's location and forwards the call to the particular MSC serving that location.

The core network 1504 also supports packet-data services with a serving GPRS support node (SGSN) 1518 and a gateway GPRS support node (GGSN) 1520. GPRS, which stands for General Packet Radio Service, is designed to provide packet-data services at speeds higher than those available with standard GSM circuit-switched data services. The GGSN 1520 provides a connection for the RAN 1502 to a packet-based network 1522. The packet-based network 1522 may be the Internet, a private data network, or some other suitable packet-based network. The primary function of the GGSN 1520 is to provide the UEs 1510 with packet-based network connectivity. Data packets are transferred between the GGSN 1520 and the UEs 1510 through the SGSN 1518, which performs primarily the same functions in the packet-based domain as the MSC 1512 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 1508 and a UE 1510, but divides uplink and downlink transmissions into different time slots in the carrier.

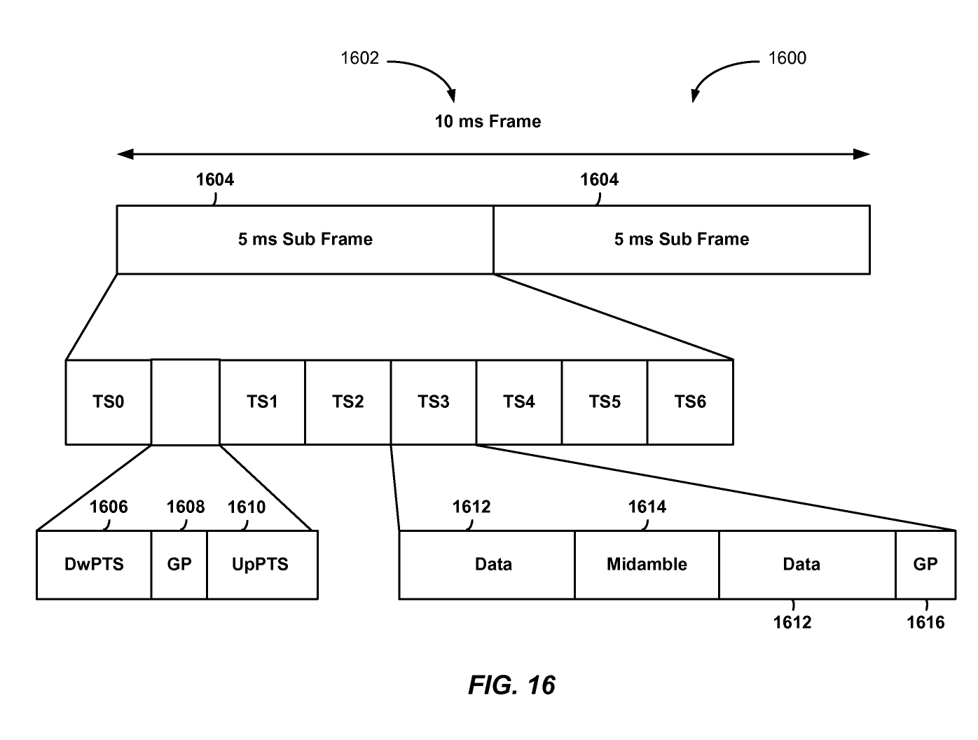

FIG. 16 shows a frame structure 1600 for a TD-SCDMA carrier, which may be used for communications between first base station 104, second base station 106, or third base station 108 of FIG. 1, and UE 102, also of FIG. 1. The TD-SCDMA carrier, as illustrated, has a frame 1602 that is 10 milliseconds (ms) in duration. The frame 1602 has two 5 ms subframes 1604, and each of the subframes 1604 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 1606, a guard period (GP) 1608, and an uplink pilot time slot (UpPTS) 1610 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 1612 separated by a midamble 1614 and followed by a guard period (GP) 1616. The midamble 1614 may be used for features, such as channel estimation, while the GP 1616 may be used to avoid inter-burst interference.

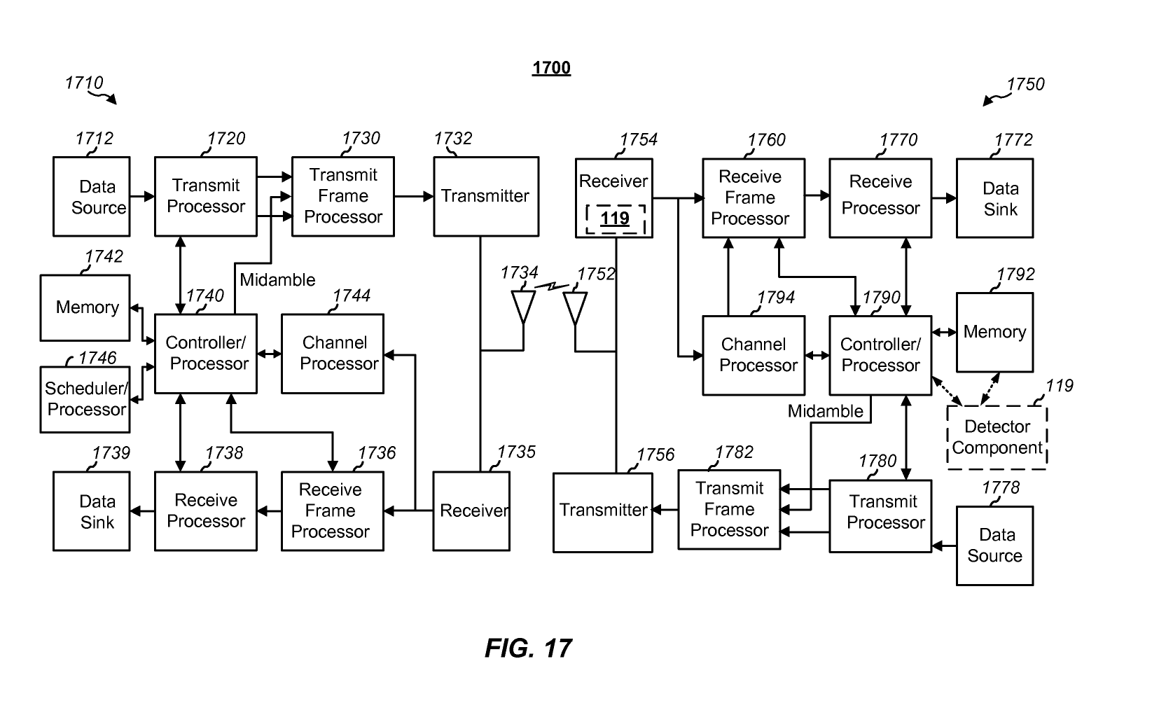

FIG. 17 is a block diagram of a Node B 1710 in communication with a UE 1750 in a RAN 1700. In an aspect, Node B 1710 may be an example of first base station 104, second base station 106, or third base station 108 of FIG. 1, and UE 1750 may be an example of UE 102 of FIG. 1 and may include and execute detector component 119 of FIG. 1, either in receiver 1754 (which may be the same as or equivalent to receiver 118 of FIG. 1) or optionally separate from receiver 1754, for example, in memory 1792 and/or controller/processor 1790, to perform any functions described herein.

In the downlink communication, a transmit processor 1720 may receive data from a data source 1712 and control signals from a controller/processor 1740. The transmit processor 1720 provides various signal processing functions for the data and control signals, as well as reference signals (e.g., pilot signals). For example, the transmit processor 1720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1744 may be used by a controller/processor 1740 to determine the coding, modulation, spreading, and/or scrambling schemes for the transmit processor 1720. These channel estimates may be derived from a reference signal transmitted by the UE 1750 or from feedback contained in the midamble 1614 (FIG. 16) from the UE 1750. The symbols generated by the transmit processor 1720 are provided to a transmit frame processor 1730 to create a frame structure. The transmit frame processor 1730 creates this frame structure by multiplexing the symbols with a midamble 1614 (FIG. 16) from the controller/processor 1740, resulting in a series of frames. The frames are then provided to a transmitter 1732, which provides various signal conditioning functions including amplifying, filtering, and modulating the frames onto a carrier for downlink transmission over the wireless medium through smart antennas 1734. The smart antennas 1734 may be implemented with beam steering bidirectional adaptive antenna arrays or other similar beam technologies.

At the UE 1750, a receiver 1754 receives the downlink transmission through an antenna 1752 and processes the transmission to recover the information modulated onto the carrier. The information recovered by the receiver 1754 is provided to a receive frame processor 1760, which parses each frame, and provides the midamble 1614 (FIG. 16) to a channel processor 1794 and the data, control, and reference signals to a receive processor 1770. The receive processor 1770 then performs the inverse of the processing performed by the transmit processor 1720 in the Node B 1710. More specifically, the receive processor 1770 descrambles and despreads the symbols, and then determines the most likely signal constellation points transmitted by the Node B 1710 based on the modulation scheme. These soft decisions may be based on channel estimates computed by the channel processor 1794. The soft decisions are then decoded and deinterleaved to recover the data, control, and reference signals. The CRC codes are then checked to determine whether the frames were successfully decoded. The data carried by the successfully decoded frames will then be provided to a data sink 1772, which represents applications running in the UE 1750 and/or various user interfaces (e.g., display). Control signals carried by successfully decoded frames will be provided to a controller/processor 1790. When frames are unsuccessfully decoded by the receiver processor 1770, the controller/processor 1790 may also use an acknowledgement (ACK) and/or negative acknowledgement (NACK) protocol to support retransmission requests for those frames.

In the uplink, data from a data source 1778 and control signals from the controller/processor 1790 are provided to a transmit processor 1780. The data source 1778 may represent applications running in the UE 1750 and various user interfaces (e.g., keyboard). Similar to the functionality described in connection with the downlink transmission by the Node B 1710, the transmit processor 1780 provides various signal processing functions including CRC codes, coding and interleaving to facilitate FEC, mapping to signal constellations, spreading with OVSFs, and scrambling to produce a series of symbols. Channel estimates, derived by the channel processor 1794 from a reference signal transmitted by the Node B 1710 or from feedback contained in the midamble transmitted by the Node B 1710, may be used to select the appropriate coding, modulation, spreading, and/or scrambling schemes. The symbols produced by the transmit processor 1780 will be provided to a transmit frame processor 1782 to create a frame structure. The transmit frame processor 1782 creates this frame structure by multiplexing the symbols with a midamble 1614 (FIG. 16) from the controller/processor 1790, resulting in a series of frames. The frames are then provided to a transmitter 1756, which provides various signal conditioning functions including amplification, filtering, and modulating the frames onto a carrier for uplink transmission over the wireless medium through the antenna 1752.

The uplink transmission is processed at the Node B 1710 in a manner similar to that described in connection with the receiver function at the UE 1750. A receiver 1735 receives the uplink transmission through the antenna 1734 and processes the transmission to recover the information modulated onto the carrier. The information recovered by the receiver 1735 is provided to a receive frame processor 1736, which parses each frame, and provides the midamble 1614 (FIG. 16) to the channel processor 1744 and the data, control, and reference signals to a receive processor 1738. The receive processor 1738 performs the inverse of the processing performed by the transmit processor 1780 in the UE 1750. The data and control signals carried by the successfully decoded frames may then be provided to a data sink 1739 and the controller/processor, respectively. If some of the frames were unsuccessfully decoded by the receive processor, the controller/processor 1740 may also use an acknowledgement (ACK) and/or negative acknowledgement (NACK) protocol to support retransmission requests for those frames.

The controller/processors 1740 and 1790 may be used to direct the operation at the Node B 1710 and the UE 1750, respectively. For example, the controller/processors 1740 and 1790 may provide various functions including timing, peripheral interfaces, voltage regulation, power management, and other control functions. The computer readable media of memories 1742 and 1792 may store data and software for the Node B 1710 and the UE 1750, respectively. A scheduler/processor 1746 at the Node B 1710 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), whichever is appropriate, unless the element is expressly recited using the phrase “means for” or, in the case of a method claim, the element is recited using the phrase “step for.”

What is claimed is:

1. A method of wireless communication, comprising:
receiving a plurality of chips in a time division synchronous code division multiple access (TD-SCDMA) network;
performing channel matched filtering, despreading, and descrambling on the plurality of chips to determine a plurality of received symbols for each of a plurality of cells;
performing symbol-level inter-cell interference cancellation on the plurality of received symbols to determine a plurality of serving cell symbol estimates; and
performing multi-user detection on the plurality of serving cell symbol estimates to determine a plurality of detected serving cell symbols.

2. The method of claim 1, wherein performing channel matched filtering, despreading, and descrambling on the plurality of chips comprises:
for a cell in the plurality of cells, performing channel matched filtering, despreading, and descrambling on the plurality of chips according to cell parameters of the cell to determine a plurality of symbols corresponding to the cell.

3. The method of claim 1, wherein the plurality of received symbols include a plurality of serving cell symbols corresponding to a serving cell, a first plurality of symbols corresponding to a first interfering cell, and a second plurality of symbols corresponding to a second interfering cell.

4. The method of claim 3, wherein performing symbol-level inter-cell interference cancellation comprises:
performing symbol-level parallel inter-cell interference cancellation to remove contributions of the first plurality of symbols and the second plurality of symbols from the plurality of serving cell symbols.

5. The method of claim 4, wherein performing symbol-level parallel inter-cell interference cancellation comprises:
performing multi-user detection separately on the first plurality of symbols and on the second plurality of symbols.

6. The method of claim 1, wherein performing multi-user detection on the plurality of serving cell symbol estimates comprises:
determining a covariance matrix corresponding to a serving cell based on symbol-to-symbol transfer matrices among the plurality of cells;
determining a cross-correlation matrix corresponding to the serving cell based on serving cell parameters of the serving cell; and
performing multi-user detection on the plurality of serving cell symbols based on the covariance matrix and the cross-correlation matrix.

7. The method of claim 6, wherein the symbol-to-symbol transfer matrices are based on cell parameters of the plurality of cells.

8. The method of claim 7, wherein the cell parameters and the serving cell parameters comprise one or more of a scrambling matrix, a Walsh code, a gain matrix, and a channel convolutional matrix.

9. An apparatus for wireless communication, comprising:
a processing system configured to:
receive a plurality of chips in a time division synchronous code division multiple access (TD-SCDMA) network;
perform channel matched filtering, despreading, and descrambling on the plurality of chips to determine a plurality of received symbols for each of a plurality of cells;
perform symbol-level inter-cell interference cancellation on the plurality of received symbols to determine a plurality of serving cell symbol estimates; and
perform multi-user detection on the plurality of serving cell symbol estimates to determine a plurality of detected serving cell symbols.

10. The apparatus of claim 9, wherein to perform channel matched filtering, despreading, and descrambling on the plurality of chips, the processing system is configured to:
for a cell in the plurality of cells, perform channel matched filtering, despreading, and descrambling on the plurality of chips according to cell parameters of the cell to determine a plurality of symbols corresponding to the cell.

11. The apparatus of claim 9, wherein the plurality of received symbols include a plurality of serving cell symbols corresponding to a serving cell, a first plurality of symbols corresponding to a first interfering cell, and a second plurality of symbols corresponding to a second interfering cell.

12. The apparatus of claim 11, wherein to perform symbol-level inter-cell interference cancellation, the processing system is configured to:
perform symbol-level parallel inter-cell interference cancellation to remove contributions of the first plurality of symbols and the second plurality of symbols from the plurality of serving cell symbols.

13. The apparatus of claim 12, wherein to perform symbol-level parallel inter-cell interference cancellation, the apparatus is configured to:
perform multi-user detection separately on the first plurality of symbols and on the second plurality of symbols.

14. The apparatus of claim 9, wherein to perform multi-user detection on the plurality of serving cell symbol estimates, the apparatus is configured to:
determine a covariance matrix corresponding to a serving cell based on symbol-to-symbol transfer matrices among the plurality of cells;
determine a cross-correlation matrix corresponding to the serving cell based on serving cell parameters of the serving cell; and
perform multi-user detection on the plurality of serving cell symbols based on the covariance matrix and the cross-correlation matrix.

15. The apparatus of claim 14, wherein the symbol-to-symbol transfer matrices are based on cell parameters of the plurality of cells.

16. The apparatus of claim 15, wherein the cell parameters and the serving cell parameters comprise one or more of a scrambling matrix, a Walsh code, a gain matrix, and a channel convolutional matrix.

17. An apparatus for wireless communication, comprising:
means for receiving a plurality of chips in a time division synchronous code division multiple access (TD-SCDMA) network;
means for performing channel matched filtering, despreading, and descrambling on the plurality of chips to determine a plurality of received symbols for each of a plurality of cells;
means for performing symbol-level inter-cell interference cancellation on the plurality of received symbols to determine a plurality of serving cell symbol estimates; and
means for performing multi-user detection on the plurality of serving cell symbol estimates to determine a plurality of detected serving cell symbols.

18. The apparatus of claim 17, wherein the means for performing channel matched filtering, despreading, and descrambling on the plurality of chips comprises:
means for, for a cell in the plurality of cells, performing channel matched filtering, despreading, and descrambling on the plurality of chips according to cell parameters of the cell to determine a plurality of symbols corresponding to the cell.

19. The apparatus of claim 17, wherein the plurality of received symbols include a plurality of serving cell symbols corresponding to a serving cell, a first plurality of symbols corresponding to a first interfering cell, and a second plurality of symbols corresponding to a second interfering cell.

20. The apparatus of claim 19, wherein the means for performing symbol-level inter-cell interference cancellation comprises:
means for performing symbol-level parallel inter-cell interference cancellation to remove contributions of the first plurality of symbols and the second plurality of symbols from the plurality of serving cell symbols.

21. The apparatus of claim 20, wherein the means for performing symbol-level parallel inter-cell interference cancellation comprises:
means for performing multi-user detection separately on the first plurality of symbols and on the second plurality of symbols.

22. The apparatus of claim 17, wherein the means for performing multi-user detection on the plurality of serving cell symbol estimates comprises:
means for determining a covariance matrix corresponding to a serving cell based on symbol-to-symbol transfer matrices among the plurality of cells;
means for determining a cross-correlation matrix corresponding to the serving cell based on serving cell parameters of the serving cell; and
means for performing multi-user detection on the plurality of serving cell symbols based on the covariance matrix and the cross-correlation matrix.

23. The apparatus of claim 22, wherein the symbol-to-symbol transfer matrices are based on cell parameters of the plurality of cells.

24. The apparatus of claim 23, wherein the cell parameters and the serving cell parameters comprise one or more of a scrambling matrix, a Walsh code, a gain matrix, and a channel convolutional matrix.

25. A computer program product for wireless communication, comprising:
a non-transitory computer-readable medium comprising:
code for receiving a plurality of chips in a time division synchronous code division multiple access (TD-SCDMA) network;
code for performing channel matched filtering, despreading, and descrambling on the plurality of chips to determine a plurality of received symbols for each of a plurality of cells;
code for performing symbol-level inter-cell interference cancellation on the plurality of received symbols to determine a plurality of serving cell symbol estimates; and
code for performing multi-user detection on the plurality of serving cell symbol estimates to determine a plurality of detected serving cell symbols.

26. The computer program product of claim 25, wherein the code for performing channel matched filtering, despreading, and descrambling on the plurality of chips comprises:
code for, for a cell in the plurality of cells, performing channel matched filtering, despreading, and descrambling on the plurality of chips according to cell parameters of the cell to determine a plurality of symbols corresponding to the cell.

27. The computer program product of claim 25, wherein the plurality of received symbols include a plurality of serving cell symbols corresponding to a serving cell, a first plurality of symbols corresponding to a first interfering cell, and a second plurality of symbols corresponding to a second interfering cell.

28. The computer program product of claim 27, wherein the code for performing symbol-level inter-cell interference cancellation comprises:
code for performing symbol-level parallel inter-cell interference cancellation to remove contributions of the first plurality of symbols and the second plurality of symbols from the plurality of serving cell symbols.

29. The computer program product of claim 28, wherein the code for performing symbol-level parallel inter-cell interference cancellation comprises:
code for performing multi-user detection separately on the first plurality of symbols and on the second plurality of symbols.

30. The computer program product of claim 25, wherein the code for performing multi-user detection on the plurality of serving cell symbol estimates comprises:
code for determining a covariance matrix corresponding to a serving cell based on symbol-to-symbol transfer matrices among the plurality of cells;
code for determining a cross-correlation matrix corresponding to the serving cell based on serving cell parameters of the serving cell; and
code for performing multi-user detection on the plurality of serving cell symbols based on the covariance matrix and the cross-correlation matrix.
